(19) United States
(12) Patent Application Publication
(10) Pub. No.: US 2026/0176912 A1
(43) Pub. Date: Jun. 25, 2026

(54) SPACER WITH IMPROVED MECHANICAL STIFFNESS

(71) Applicant: SAINT-GOBAIN GLASS FRANCE, COURBEVOIE (FR)

(72) Inventors: Nikolai BORCHMANN, HERZOGENRATH (DE); Walter SCHREIBER, HERZOGENRATH (DE); Christopher MARJAN, HERZOGENRATH (DE); Rémi DELEURENCE, HERZOGENRATH (DE); Jonas BOUSMAT, HERZOGENRATH (DE)

(21) Appl. No.: 18/856,485

(22) PCT Filed: Apr. 11, 2023
(86) PCT No.: PCT/EP2023/059441

§ 371 Date: Oct. 11, 2024

(30) Foreign Application Priority Data
Apr. 14, 2022 (EP) 22168277.6

(51) Int. Cl. E06B 3/663; E06B 3/673

(52) U.S. Cl. CPC E06B 3/66333; E06B 3/66352; E06B 3/67313; E06B 3/67321

(57) ABSTRACT

A spacer for insulating glass units includes a polymer hollow profile extending in the longitudinal direction, having first and second side walls arranged parallel thereto, a glazing interior wall extending in the transverse direction between the side walls and connects them to one another, an outer wall arranged at least partially parallel to the glazing interior wall and perpendicular to the side walls and connects the side walls to one another, and a cavity enclosed by the side walls, the glazing interior wall and the outer wall, a plurality of continuous fibers, wherein each continuous fiber has a fiber length along its extension which corresponds to a dimension of the polymer hollow profile along the extension of the continuous fiber.

The invention relates to a spacer for insulating glass units, an insulating glass unit, a method for producing an insulating glass unit, and the use thereof.

Insulating glazings generally contain at least two panes made of glass or of polymeric materials. The panes are separated from one another by a gas or vacuum space defined by the spacer. The thermal insulation capability of insulating glass is significantly higher than that of single glazing and can be even further increased and improved in triple glazings or with special coatings. For example, silver-containing coatings enable reduced transmission of infrared radiation and thus reduce the cooling of a building in winter.

In addition to the nature and structure of the glass, the further components of an insulating glazing are also of great importance. The seal and the spacer have a great influence on the quality of the insulating glazing. Above all, the contact points between the spacer and the glass pane are very susceptible to temperature and climate fluctuations. The connection between the pane and the spacer is produced by means of an adhesive bond made of organic polymer, e.g., polyisobutylene. In addition to the direct effects of the temperature fluctuations on the physical properties of the adhesive bond, the glass itself has a strong effect on the adhesive bond. The glass and the spacers have different thermal linear expansion coefficients, i.e., they expand to a different extent in the event of temperature changes. Due to the temperature changes, for example by solar radiation, the glass expands or contracts again upon cooling. The spacer does not make these movements to the same extent. This mechanical movement therefore stretches or compresses the adhesive bond, which can compensate for these movements only to a limited extent through their own elasticity. In the course of the service life of the insulating glazing, the described mechanical stress can mean a partial or full-area detachment of the adhesive bond. This detachment of the adhesive bond can subsequently allow a penetration of air humidity inside the insulating glazing. These climatic loads can result in fogging in the region of the panes and a reduction in the insulating effect. It is therefore desirable to equalize the coefficient of linear expansion of glass and spacers as far as possible.

The thermally insulating properties of insulating glazings are substantially influenced by the thermal conductivity in the region of the edge bond, in particular of the spacer. In the case of metallic spacers, the high thermal conductivity of the metal results in the formation of a thermal bridge at the edge of the glass. On the one hand, this thermal bridge leads to heat losses in the edge region of the insulating glazing and, on the other hand, with high air humidity and low external temperatures, to the formation of condensate on the inner pane in the region of the spacer. In order to solve these problems, thermally optimized, so-called “warm-edge” systems are increasingly used, in which the spacers consist of materials of lower thermal conductivity, in particular plastics.

With regard to thermal conductivity, polymer spacers are preferred over metallic spacers. However, polymer spacers have several disadvantages. On the one hand, the tightness of the polymer spacers against moisture and gas loss is insufficient. There are various solutions here, in particular the application of a barrier film as a diffusion barrier to the outside of the spacer (see, for example, WO 2013/104507 A1 and WO 2016/046081 A1).

On the other hand, the coefficients of linear expansion of plastics are much greater than that of glass. For example, glass fibers or glass spheres can be added to equalize the coefficient of linear expansion (see, for example, EP 0852280 A1). However, an increased glass fiber content impairs the heat-conducting properties of the spacer, so that a precise optimization must take place in this case. Glass fibers and similar fillers additionally improve the longitudinal rigidity of the spacer.

Spacer frames for an insulating glass unit can be produced by connecting multiple pieces of spacers via plug connectors and subsequent gluing or welding. Each connection point must be carefully sealed. The production of a spacer frame by bending is therefore advantageous since in this case a connection point only needs to be sealed at one point. In particular, bending without additional heating is desirable for simple machine processability. One approach for increasing the bendability without heating is the integration of a metallic strip into the polymer main body. For example, in DE 19807454 A1 and in WO 2015/043848 A1, the integration of a metallic reinforcing element exclusively in the side walls is described. This improves the cold bendability of the hollow profile, but the longitudinal rigidity is low. The processing of the hollow profile into a spacer frame is therefore made more difficult since the hollow profiles greatly sag. WO 9941481A1 and EP 3241972 A1 disclose the arrangement of reinforcing elements in the region of the side walls and in part also in the region of further walls.

The mechanical longitudinal stiffness (relates to the sag in the longitudinal direction) is important for machine processability. An improvement in the longitudinal rigidity can be achieved by the integration of metallic strips, as described above, or the external application of metallic elements on the body (see, for example, WO 2012055553 A1 and WO 2019201530 A1) or the introduction of glass fibers. As revealed in practice, spacers with glass fibers in particular tend to break at the bending points during cold bending so that the reject rate is undesirably high.

Spacers with continuous fibers can be found in U.S. Pat. No. 5,079,054 A, EP 3241972 A1, EP 2561169 B1 and U.S. Pat. No. 6,537,629 B1.

It is the object of the present invention to provide an improved spacer which does not have the above-mentioned disadvantages, and an improved insulating glass unit and a simplified method for the production thereof, wherein the spacer is to have a high mechanical stiffness with a very good thermal insulation effect.

The object of the present invention is achieved according to the invention by a spacer for insulating glass units according to independent claim 1. Preferred embodiments of the invention are apparent from the dependent claims.

An insulating glass unit according to the invention, a method for producing the insulating glass unit according to the invention, and its use according to the invention emerge from further independent claims.

The spacer according to the invention for insulating glass units comprises an elongated polymer hollow profile with a first side wall, a second side wall arranged parallel thereto, a glazing interior wall, an outer wall and a cavity. The cavity is enclosed by the side walls, the glazing interior wall and the outer wall. The polymer hollow profile is elongated and extends in a longitudinal direction X. The glazing interior wall extends between the two side walls in a transverse direction Y perpendicular thereto. The glazing interior wall is arranged here substantially perpendicular to the side walls and connects the first side wall to the second side wall. The side walls are the walls of the hollow profile to which the outer panes of the insulating glass unit are attached. The glazing interior wall is the wall of the hollow profile that faces the inner pane interspace after installation in the finished insulating glass unit. The outer wall is arranged at least partially parallel to the glazing interior wall and connects the first side wall to the second side wall. The outer wall therefore comprises at least one section running parallel to the glazing interior wall. After installation in the finished insulating glass unit, the outer wall faces the outer pane interspace.

The spacer according to the invention comprises a plurality of continuous fibers, wherein each continuous fiber has a fiber length along its extension which corresponds to a dimension of the polymer hollow profile along the extension of the continuous fiber. The fiber length of the continuous fibers therefore corresponds in each case to a dimension of the polymer hollow profile in the direction of the fiber.

In the context of the present invention, the term “continuous fiber” denotes a fiber which extends over the complete dimension of the polymer hollow profile relative to the direction of the continuous fiber. When the continuous fiber extends in the longitudinal direction of the polymer hollow profile, then the fiber length (i.e., dimension of the continuous fiber along its extension) corresponds to the dimension of the polymer hollow profile in the longitudinal direction. If the continuous fiber extends in the transverse direction of the polymer hollow profile, then the fiber length corresponds to the dimension of the polymer hollow profile in the transverse direction. If the endless fiber extends in an oblique direction which has an angle different from 0° and 90° (transverse direction) relative to the longitudinal direction of the polymer hollow profile, then the fiber length corresponds to the dimension of the polymer hollow profile in this oblique direction.

In other words, each continuous fiber begins and ends in each case on an upper or outer surface of the polymer hollow profile. When the continuous fiber extends in the longitudinal direction of the polymer hollow profile, then the continuous fiber begins at an end-face surface of the polymer hollow profile and ends at the opposite end-face surface of the polymer hollow profile in the longitudinal direction. The two end-face surfaces delimit the polymer hollow profile in the longitudinal direction. If the continuous fiber extends in the transverse direction of the polymer hollow profile, then the continuous fiber begins at a lateral surface of the polymer hollow profile and ends at the opposite lateral surface of the polymer hollow profile in the transverse direction. The two lateral surfaces delimit the polymer hollow body in the transverse direction. If the continuous fiber extends in the oblique direction of the polymer hollow profile, then the continuous fiber begins at an end-face or lateral surface of the polymer hollow profile and ends at the opposite lateral surface in the transverse direction, or the opposite end-face outer wall of the polymer hollow profile in the longitudinal direction, depending on the orientation of the continuous fiber.

The design as continuous fibers substantially distinguishes the fibers of the spacer according to the invention from conventional fibers which are embedded in a polymer hollow profile as a reinforcement. In the prior art, exclusively so-called short or long fibers are used. In the final product, short fibers typically have a length of 100 μm to 1 mm. The length of long fibers is typically in the range of 1 mm to 50 mm. Continuous fibers are longer than 50 mm, wherein the length of the continuous fibers in the spacer according to the invention satisfies the above-formulated dimensioning rules. In contrast to continuous fibers, the short or long fibers do not always begin and end on outer walls of the polymer hollow profile since the fiber length of a short fiber or long fiber does not in any case correspond to a dimension of the polymer hollow profile in the direction of the fiber.

The material of the continuous fibers can as such be selected as desired as long as it is ensured that the spacer achieves improved mechanical rigidity, in particular longitudinal rigidity, by the continuous fibers, and the fiber material has advantageous properties relative to the matrix material. The continuous fibers can consist of an organic or inorganic material, in particular of glass, aramid or carbon. The materials used for conventional reinforcing fibers are particularly preferred with regard to mechanical properties.

As the inventors have found, the continuous fibers can significantly improve the mechanical stiffness, in particular mechanical longitudinal rigidity, of the spacer without abandoning the thermal insulation capability. Particularly advantageous for the spacer is improved longitudinal rigidity by aligning the continuous fibers in the longitudinal direction of the spacer. The spacer therefore has a certain stiffness with respect to sagging under its own weight. The continuous fibers prevent bulging in the corners of a spacer frame while bending. Furthermore, the spacer is not brittle, as is the case with spacers with short fibers. The spacer according to the invention therefore has good mechanical stability, safe processability and thermal insulation capability. In any case, the heat conduction is advantageously much worse than with metallic spacers, which also ensure good mechanical rigidity. A simultaneous implementation of these properties is otherwise very difficult to achieve, if at all. The spacer according to the invention also offers in particular the possibility of producing a spacer frame by bending at low temperatures such as room temperature, wherein the improvement of the mechanical longitudinal stiffness is significant. These are important advantages of the spacer according to the invention, which enable production of insulating glass units with a relatively low reject rate, whereby the production of insulating glass units in industrial mass production can be time-saving and cost-effective.

According to an advantageous embodiment of the spacer according to the invention, the continuous fibers have an identical extension direction. The same orientation of the continuous fibers can advantageously improve the mechanical stiffness of the spacer transversely to the extension of the continuous fibers. In particular, the longitudinal rigidity of the spacer can thereby be significantly improved. For practical application, it is very advantageous if the longitudinal rigidity is improved so that the (common) extension direction of the continuous fibers is preferably the longitudinal direction (X) of the polymer hollow profile, i.e., the continuous fibers are deflected transversely to their extension. In this case, the continuous fibers start at an end side outer surface and end at the opposite end side outer surface of the polymer hollow profile in the longitudinal direction.

According to a further advantageous embodiment of the spacer according to the invention, the continuous fibers of a first set of continuous fibers each have a first extension direction which preferably corresponds to the longitudinal direction (X) of the polymer hollow profile, and the continuous fibers of at least one second set of continuous fibers each have a second extension direction which is different from the first extension direction. The continuous fibers of the first set of continuous fibers therefore extend in a (same) first direction. The continuous fibers of the at least one second set of continuous fibers therefore extend in a (same) second direction. Any number of sets of continuous fibers can be provided, wherein the continuous fibers of a same set each extend in a same direction. The number of second sets is not limited. For example, exactly one first set of continuous fibers and exactly one second set of continuous fibers are provided, wherein the continuous fibers extend in a first direction, and the continuous fibers of the second set extend in a second direction which has an angle within a range of greater than 0° and 90° relative to the first direction. The first direction is preferably the longitudinal direction (X) of the polymer hollow profile due to the preferred mechanical stiffness of the spacer transversely to the longitudinal direction. By means of the at least one second set of continuous fibers which extend along the second direction, good mechanical rigidity can advantageously also be realized in another direction, preferably in addition to the good mechanical stiffness of the spacer transversely to the longitudinal direction. Multiple second sets with continuous fibers can also be provided, wherein the continuous fibers of different second sets have different orientations.

The same orientation of the continuous fibers of at least one set of continuous fibers, in particular the same orientation of all continuous fibers, furthermore distinguishes the continuous fibers from the short and long fibers of the prior art, which can have, in regions, a certain preferred direction by extrusion, but are basically oriented differently.

In the context of the present invention, the same orientation of continuous fibers exists if at least 90%, preferably at least 95%, particularly preferably at least 99%, of the considered set of continuous fibers, in particular all continuous fibers, are directed in the same direction. It is understood that, due to the production process, it cannot be ruled out that individual continuous fibers have a deviating direction.

Depending on the application, the continuous fibers can be present in a wide variety of forms. For example, the continuous fibers are in the form of individual fibers (“rovings”). The individual fibers do not have any connection to one another. The individual fibers of at least one set of continuous fibers, in particular all continuous fibers, are preferably arranged parallel to one another. However, it is also possible for the continuous fibers to be contained in a woven composite, for example in the form of a mesh-like lattice. For example, the continuous fibers of a woven composite are oriented only in a first direction which preferably is the longitudinal direction of the spacer, and are only oriented in a second direction that is perpendicular to the first direction.

It is also possible for the continuous fibers to be present in a non-woven composite (nonwoven). There is no preferred direction of the continuous fibers in a nonwoven.

In the spacer according to the invention, the continuous fibers are embedded in a polymer carrier which preferably consists of a thermoplastic material. The carrier is structurally different from the polymer hollow profile, wherein the carrier with the continuous fibers in turn is embedded in the hollow profile or is arranged on a surface of the hollow profile. Embedding the continuous fibers in the polymer carrier can make it easier to produce the spacer since the carrier with the continuous fibers can be provided already prefabricated.

Particularly preferably, the polymer carrier consists of a polymer material which is the same as a polymer material from which the polymer hollow profile consists. This can have procedural advantages since the two polymer materials can be fused well to one another in order to thereby create a particularly firm connection between the polymer carrier and the polymer hollow profile. For example, the carrier contains polyethylene (PE), polycarbonate (PC), polypropylene (PP), polyethylene terephthalate (PET), polyethylene terephthalate glycol (PET-G), crosslinked polyethylene terephthalate (PET-X), polyoxymethylene (POM), polyamide, polybutylene terephthalate (PBT), PET/PC, PBT/PC, styrene-acrylonitrile copolymer (SAN), acrylonitrile-butadiene-styrene copolymer (ABS) and/or copolymers and/or derivatives thereof. In a particularly preferred embodiment, the carrier consists substantially of one of the listed polymers. It is possible for the carrier to be a tape. The carrier can be connected to the hollow profile by means of an adhesive or by welding.

In the spacer according to the invention, the carrier is arranged with the continuous fibers on the outer surface of at least one wall of the polymer hollow profile. The carrier with the continuous fibers is therefore arranged on a surface of the glazing interior wall, and/or a surface of the outer wall, and/or a surface of the first side wall, and/or a surface of the second side wall. This embodiment has the advantage that the polymer hollow profile can be produced in a conventional manner, wherein the carrier can be fastened to the polymer hollow profile by means of the continuous fibers after the production of the polymer hollow profile.

A carrier with continuous fibers is preferably arranged on a surface of the glazing interior wall and/or a surface of the outer wall, wherein a carrier with continuous fibers can additionally be arranged on a surface of the first side wall and/or a surface of the second side wall. Particularly preferably, the continuous fibers preferably extend in the form of individual fibers in the longitudinal direction (X) of the polymer hollow body. A carrier with continuous fibers is, for example, connected to the polymer hollow profile by gluing or welding, wherein welding requires that the materials of the carrier and hollow profile are compatible. The materials of the carrier and hollow profile are preferably the same.

According to one embodiment, a diffusion barrier is applied, for example, in the form of a gas-tight and moisture-tight barrier film on the first side wall, on the outer wall and on the second side wall of the polymer hollow profile. The diffusion barrier seals the inner pane interspace against the penetration of moisture and prevents the loss of a gas contained in the inner pane interspace. It is advantageous in this case if the continuous fibers are embedded in the diffusion barrier. In this way, the diffusion barrier is given a dual function as a barrier layer and means for improving the mechanical rigidity of the spacer.

According to one embodiment of the spacer according to the invention, the continuous fibers are additionally embedded in at least one wall of the polymer hollow profile. The continuous fibers are therefore embedded in the glazing interior wall, and/or the outer wall, and/or the first side wall, and/or the second side wall of the polymer hollow profile.

The continuous fibers are preferably embedded in the glazing interior wall and/or the outer wall of the polymer hollow profile, wherein the continuous fibers can optionally also be embedded in the first side wall and/or the second side wall of the polymer hollow profile. Particularly preferably, the continuous fibers preferably extend in the form of individual fibers in the longitudinal direction (X) of the polymer hollow body

The cavity of the spacer according to the invention leads to a reduction in weight compared to a solidly formed spacer and is available for receiving further components, such as a desiccant.

The first side wall and the second side wall represent the sides of the spacer on which the mounting of the outer panes of an insulating glazing takes place when the spacer is installed. The first side wall and the second side wall run parallel to one another. The outer wall of the hollow profile is the wall that is opposite the glazing interior wall and faces away from the interior of the insulating glass unit (inner pane interspace) in the direction of the outer pane interspace. The outer wall preferably runs substantially perpendicular to the side walls.

In a preferred embodiment of the spacer according to the invention, the connecting walls that are closest to the side walls are inclined in the direction of the side walls at an angle of 30° to 60° to the outer wall. This embodiment improves the stability of the polymeric hollow profile. Preferably, the portions closest to the connecting walls are inclined at an angle of 45°. In this case, the stability of the spacer is further improved.

In a preferred embodiment, the diffusion barrier is applied in such a way that the regions of the two side walls bordering the interior glazing wall are free of the diffusion barrier. By attaching to the entire outer wall up to the side walls, a particularly good sealing of the spacer is achieved. The advantage of the regions on the side walls that remain free from the diffusion barrier is on the one hand an improvement of the optical appearance in the installed state. In the case of a barrier which adjoins the glazing interior wall or is even part of the glazing interior wall, it is visible in the finished insulating glass unit. This is to be avoided for aesthetic reasons. A further advantage of the free regions on the side walls is that, during installation in the finished insulating glass unit, the primary sealant can be attached such that it extends over the diffusion barrier and over a piece of the polymer side wall. A uniform sealing plane is therefore attained, and particularly good sealing is achieved. The height of the region that remains free from the diffusion barrier is preferably between 1 mm and 3 mm. In this embodiment, the diffusion barrier is not visible in the finished insulating glass unit, and the visual impression is therefore advantageous. In addition, the primary sealant can be attached in the finished insulating glazing in such a way that the primary sealant is attached to the plastic of the side walls and the diffusion barrier. Thus, interface diffusion at the transition from the diffusion barrier to the plastic is significantly reduced.

It is conceivable that the hollow profile contains fillers that are different from the continuous fibers. With the aid of the fillers, material properties such as mechanical strength, stiffness, and dimensional stability can be further adapted. A wide variety of reinforcing agents in fiber, powder or platelet form are known to a person skilled in the art. Powder and/or platelet reinforcing agents include, for example, mica, chalk and talcum. Particularly preferred with regard to mechanical properties are reinforcing fibers (short and/or long fibers) among which glass fibers, aramid fibers, ceramic fibers or natural fibers are to be expected. Alternatives to this are also ground glass fibers or hollow glass spheres. These hollow glass spheres have a diameter of 10 μm to 20 μm and improve the stability of the polymer hollow profile. Suitable hollow glass spheres are commercially available under the name “3M™ Glass Bubbles.” In one possible embodiment, the polymer hollow profile contains both glass fibers and hollow glass spheres. An admixture of hollow glass spheres leads to a further improvement in the thermal properties of the hollow profile. Particularly preferably, the polymer hollow profile contains talcum and/or glass beads as fillers. The polymer hollow profile preferably contains up to 15 percent by volume glass beads. The polymer hollow profile preferably contains up to 20 percent by weight talcum.

In a preferred embodiment of the spacer according to the invention, the polymer hollow profile has a substantially uniform wall thickness d. This leads to an improvement in bendability compared to hollow profiles with regions of different wall thicknesses. It has been shown that, with a uniform wall thickness, fewer fractures of the spacer occur during cold bending than with different wall thicknesses.

In a preferred embodiment, the wall thickness d is from 0.5 mm to 1.5 mm. In this region, the spacer is stable and at the same time flexible enough to be cold-bendable. The wall thickness d is particularly preferably from 0.6 mm to 1.2 mm, especially preferably 0.8 mm to 1.0 mm. The best results are achieved with these wall thicknesses. Deviations of 0.1 mm upwards and downwards are possible due to production.

In a preferred embodiment of the spacer according to the invention, the hollow profile contains polyethylene (PE), polycarbonate (PC), polypropylene (PP), polyethylene terephthalate (PET), polyethylene terephthalate glycol (PET-G), crosslinked polyethylene terephthalate (PET-X), polyoxymethylene (POM), polyamides, polybutylene terephthalate (PBT), PET/PC, PBT/PC styrene-acrylonitrile copolymer (SAN), acrylonitrile-butadiene-styrene copolymer (ABS) and/or copolymers and/or derivatives thereof. In a particularly preferred embodiment, the hollow profile consists substantially of one of the listed polymers. These materials provide particularly good results with regard to the required flexibility, which is required for the bendability of the spacer without additional heating. In addition, the mechanical stiffness can be improved by the continuous fibers in a desired manner.

In a preferred embodiment, the polymer hollow profile consists of a foamed polymer. The inclusion of air-filled pores in the hollow profile reduces thermal conductivity and therefore improves the thermal insulating property of the hollow profile. The use of foaming agents in the production of spacers is described, for example, in EP 2930296 A1.

In a preferred embodiment, the glazing interior wall has at least one perforation (opening). Preferably, a plurality of perforations are formed in the glazing interior wall. The total number of perforations depends on the size of the insulating glass unit. The perforations in the glazing interior wall connect the hollow space to the inner pane interspace, thereby enabling a gas exchange between them. This allows absorption of air moisture by a desiccant located in the cavity and thus prevents the panes from fogging. The perforations are preferably designed as slots, particularly preferably as slots of a width of 0.2 mm and a length of 2 mm. The slots ensure optimal air exchange without desiccant being able to penetrate from the cavity into the inner pane interspace. After production of the hollow profile, the perforations can simply be punched or drilled into the glazing interior wall. The perforations are preferably punched hot into the glazing interior wall.

In an alternative preferred embodiment, the material of the glazing interior wall is porous or designed with a plastic that is open to diffusion, so that perforations are not required.

The diffusion barrier is preferably a barrier film and prevents the penetration of moisture into the cavity of the spacer. The barrier film can be a metal foil, or polymer film, or a multilayer film with polymer and metallic layers, or with polymer and ceramic layers, or with polymer, metallic and ceramic layers. The barrier film is preferably a gas-tight and moisture-tight barrier film.

The terms gas-tight and moisture-tight refer to gas diffusion tightness and vapor diffusion tightness to the relevant gases (for example nitrogen, oxygen, water, and argon). The employed materials are then gas- or vapor-tight if preferably no more than 1% of the gases in the pane interspace can escape within a year. Diffusion-tight is also equated with low diffusion in the sense that the corresponding test standard EN 1279 parts 2+3 is preferably fulfilled, i.e., the finished spacer preferably fulfills the test standard EN 1279 parts 2+3.

The diffusion barrier is preferably a barrier film. The barrier film is preferably a multilayer film with polymer layers and metallic layers, or with polymer and ceramic layers, or with polymer, metallic and ceramic layers. The barrier film preferably contains at least one polymer layer and a metallic layer or a ceramic layer.

Preferably, the layer thickness of the polymer layers is between 5 μm and 80 μm, preferably from 5 μm to 24 μm, particularly preferably from 10 μm to 15 μm. Polymer layers with these layer thicknesses can be effectively coated and laminated. The barrier film preferably contains one, two, three, four or more polymer layers.

Ceramic layers are characterized by low heat conduction, which further improves the thermal insulating properties of the spacer. The ceramic layers preferably contain or consist of a silicon oxide and/or a silicon nitride.

The barrier film preferably comprises at least one thin ceramic layer having a thickness between 10 nm and 300 nm, particularly preferably from 20 nm to 200 nm. These layer thicknesses lead to a particularly good barrier effect. To improve the barrier effect and to prevent loss of tightness while bending the spacer, the ceramic layers are preferably used in combination with further ceramic and/or metallic layers.

Metallic layers are characterized by an excellent barrier effect against the ingress of moisture, and by sealing against gas loss. According to the invention, a metallic layer can comprise both pure metals as well as oxides thereof and alloys thereof. The metallic layers preferably comprise aluminum, silver, copper, gold, or alloys or oxides thereof, or consist thereof. These are characterized by particularly high tightness.

The barrier film preferably comprises at least one thin metallic layer having a thickness between 10 nm and 300 nm. These thin metallic layers contribute only slightly to increasing the thermal conductivity of the barrier film, but are more susceptible to leaks that can occur during bending. Thin metallic layers are therefore preferably used in combination with further metallic layers and/or ceramic layers.

The barrier film preferably comprises at least one, preferably precisely one, thick metallic layer having a thickness between 2 μm and 8 μm, particularly preferably between 3 μm and 7 μm. It has been shown that thick metallic layers do not lose their tightness during bending. Fewer individual layers are therefore necessary than with a structure with many thin metallic layers, which can be produced more easily. Particularly preferably, the barrier film comprises a thick metallic layer of elemental aluminum.

The barrier film preferably comprises exactly one thick metallic layer, at least one polymer layer, and at least one thin ceramic layer, and/or at least one thin metallic layer. The layer sequence is preferably: polymer layer-thin metallic layer or thin ceramic layer-thick metallic layer. This structure has proven to be extremely stretchable, which is of great importance at the corners of a cold-bent spacer frame.

Alternatively, the barrier film preferably contains at least two thin metallic layers and/or at least two thin ceramic layers which are arranged alternately with at least one polymer layer. Preferably, the outer layers are formed by the polymer layer. The thin metallic and ceramic layers are therefore particularly well protected from mechanical damage. Alternatively, the outer layers are preferably formed of metallic or ceramic layers. These improve the adhesion properties to the secondary sealant. The use of a barrier film with an alternating layer sequence is particularly advantageous with regard to the tightness of the system. An error in one of the layers does not lead to a loss of function of the barrier film. In comparison, in the case of a single layer, even a small defect can cause a complete failure. Furthermore, the application of several thin layers is advantageous in comparison with a thick layer, since the risk of internal adhesion problems increases with increasing layer thickness.

Furthermore, thicker layers have a higher conductivity so that such a film is thermodynamically less suitable.

The thin metallic and ceramic layers are preferably deposited by a PVD process (physical vapor deposition). Coating methods for films with thin layers in the nanometer range are known and are used, for example, in the packaging industry. A metallic thin layer can be applied to a polymer film, for example by sputtering in the required thickness of between 10 nm and 300 nm. This coated film can then be laminated with a thick metallic layer in a thickness in the μm range, and the barrier film can thus be obtained. Such a coating can be on one or both sides.

The polymer layers of the barrier film preferably comprise polyethylene terephthalate, ethylene vinyl alcohol, polyvinylidene chloride, polyamides, polyethylene, polypropylene, silicones, acrylonitriles, polyacrylates, polymethyl acrylates and/or copolymers or mixtures thereof.

In a preferred embodiment, the barrier film contains an adhesion-promoting layer which serves to improve the adhesion of the secondary sealant in the finished insulating glazing. This adhesion-promoting layer is arranged as the outermost layer of the barrier film so that it is in contact with the secondary sealant in the finished insulating glazing. A chemical pretreatment, a ceramic adhesive layer or a metallic adhesive layer comes into consideration as an adhesion promoter layer. The metallic adhesive layer preferably has a thickness of between 5 nm and 30 nm. According to the invention, a metallic adhesive layer can comprise both pure metals as well as oxides thereof and alloys thereof. The metallic adhesive layer preferably includes or is made of aluminum, titanium, nickel, chromium, iron or alloys, or oxides thereof. These have good adhesion to the adjacent sealant. Preferred alloys are stainless steel and TiNiCr.

The hollow profile preferably has a width of 5 mm to 55 mm, preferably of 10 mm to 20 mm, along the glazing interior wall. Within the meaning of the invention, the width v is the dimension extending between the side walls. The width is the distance between the surfaces of the two side walls that face away from one another. The distance between the panes of the insulating glass unit is determined by the selection of the width of the glazing interior wall. The exact dimensions of the glazing interior wall depend on the dimensions of the insulating glass unit and the desired pane interspace size.

The hollow profile preferably has a height of 5 mm to 15 mm, particularly preferably of 5 mm to 10 mm, along the side walls. In this height range, the spacer has an advantageous stability but is otherwise advantageously inconspicuous in the insulating glass unit. In addition, the cavity of the spacer has an advantageous size for receiving an appropriate quantity of desiccant. The height of the spacer is the distance between the surfaces of the outer wall and of the glazing interior wall that face away from one another.

The cavity preferably contains a desiccant, preferably silica gels, molecular sieves, CaCl₂), Na₂SO₄, activated carbon, silicates, bentonites, zeolites, and/or mixtures thereof.

The spacer can be produced by methods known per se. Continuous fibers made in the form of individual fibers (rovings) are embedded in the polymer hollow profile advantageously by pultrusion with thermoplastic matrix material. This is an extrusion method well known to a person skilled in the art in which the continuous fibers are unwound from bobbins and supplied to the thermoplastic material for producing the polymer hollow profile. In the process, the thermoplastic material for producing the hollow profile flows around the continuous fibers, which enables a very strong direct connection for a positive improvement of the mechanical properties. The continuous fibers are preferably embedded in the polymer hollow profile by pultrusion.

The continuous fibers can be embedded in a polymer carrier in an analogous manner in a pultrusion process with thermoplastic matrix material. The carrier with the continuous fibers can then in turn be coextruded with the polymer hollow profile. The connection to an outer surface of the polymer hollow profile is also possible, for example by using an adhesive or by welding. The polymer carrier can also be designed as an adhesive tape.

The invention furthermore comprises an insulating glass unit with a first pane, a second pane, a circumferential spacer according to the invention arranged between the first and second panes, an inner pane interspace and an outer pane interspace. The spacer according to the invention is arranged to form a circumferential spacer frame. The first pane is attached to the first side wall of the spacer by means of a primary sealant, and the second pane is attached to the second side wall by means of a primary sealant. This means that a primary sealant is arranged between the first side wall and the first pane and between the second side wall and the second pane. In this case, the primary sealant is in contact with the diffusion barrier which is attached to the side walls and the outer wall. The first pane and the second pane are arranged parallel and preferably congruently. The edges of the two panes are therefore arranged flush in the edge region, i.e., they are located at the same height. The inner pane interspace is delimited by the first and second panes and the glazing interior wall. The outer pane interspace is defined as the space that is delimited by the first pane, the second pane and the diffusion barrier on the outer wall of the spacer. The outer pane interspace is at least partially filled with a secondary sealant. The secondary sealant contributes to the mechanical stability of the insulating glass unit and absorbs a portion of the climate burdens that act on the edge bond.

In a preferred embodiment of the insulating glass unit according to the invention, the primary sealant extends up to the regions of the first and second side wall adjacent to the glazing interior wall, which preferably are free of the diffusion barrier. The primary sealant thereby covers the transition between the polymer hollow profile and the diffusion barrier so that a particularly good sealing of the insulating glass unit is achieved. In this way, the diffusion of moisture into the cavity of the spacer is reduced at the location where the diffusion barrier is adjacent to the plastic (less interface diffusion).

The primary sealant preferably contains a polyisobutylene. The polyisobutylene may be a crosslinking or non-crosslinking polyisobutylene. The sealant is preferably introduced into the gap between the spacer and panes in a thickness of 0.1 mm to 0.8 mm, particularly preferably 0.2 mm to 0.4 mm.

In a preferred embodiment, the secondary sealant is applied such that the entire outer pane interspace is completely filled with secondary sealant. This leads to maximum stabilization of the insulating glass unit.

The secondary sealant preferably contains polymers or silane-modified polymers, particularly preferably organic polysulfides, silicones, room-temperature cross-linking (RTV) silicone rubber, peroxide-crosslinked silicone rubber and/or addition-crosslinked silicone rubber, polyurethanes and/or a hot-melt. These sealants have a particularly good stabilizing effect.

The first pane and the second pane of the insulating glass unit preferably contain glass, ceramic and/or polymers, particularly preferably quartz glass, borosilicate glass, soda-lime glass, polymethyl methacrylate or polycarbonate.

The first pane and the second pane have a thickness of 2 mm to 50 mm, preferably 3 mm to 16 mm, wherein the two panes may also have different thicknesses.

In a particularly preferred embodiment of the invention, the insulating glass unit comprises at least three panes, wherein a further spacer frame is attached to the first pane and/or the second pane, to which frame the at least third pane is fastened.

In principle, a wide variety of geometries of the insulating glass unit are possible, e.g., rectangular, trapezoidal and rounded shapes. To produce round geometries, the spacer can be bent.

The first pane, the second pane and further panes can be made of single-pane safety glass, of thermally or chemically tempered glass, of float glass, of extra-clear low-iron float glass, colored glass, or of laminated safety glass containing one or more of these components. The panes can have any further components or coatings, for example low-E layers or other sun protection coatings.

In a preferred embodiment of the insulating glass unit according to the invention, the spacer frame consists of one or more spacers according to the invention. Preferably, a spacer according to the invention is bent into a complete frame and connected or welded at one point via a plug connector. It can also be multiple spacers according to the invention which are linked to one another via one or more plug connectors. The plug connectors may be designed as longitudinal connectors or corner connectors. Such corner connectors may be designed, for example, as a plastic molded part with a seal, in which two spacers provided with a miter cut abut.

In a further embodiment, the insulating glazing comprises more than two panes. In this case, the spacer can contain, for example, grooves in which at least one further pane is arranged. A plurality of panes could also be formed as a laminated glass pane.

The invention further comprises a method for producing an insulating glass unit according to the invention comprising the steps:
providing a spacer according to the invention,
bending the spacer into a spacer frame which is closed at one point,
providing a first pane and a second pane,
fastening the spacer by means of a primary sealant between the first pane and the second pane,
compressing the pane arrangement of the two panes and the spacer, and
filling the outer pane interspace with a secondary sealant.

The insulation glass unit is produced automatically in double-glazing systems known to the person skilled in the art. First, a spacer frame comprising the spacer according to the invention is provided. The spacer frame is preferably produced by bending the spacer according to the invention into a frame which is closed at one point by welding, gluing, and/or by means of a plug connector. A first pane and a second pane are provided and the spacer frame is fixed between the first and the second pane by means of a primary sealant. The spacer frame is placed with the first side wall of the spacer onto the first pane and fastened by means of the primary sealant. The second pane is then placed congruently with the first pane onto the second side wall of the spacer and likewise fastened by means of the primary sealant, and the pane arrangement is compressed. The outer pane interspace is at least partially filled with a secondary sealant. The method according to the invention thus enables the simple and cost-effective production of an insulation glass unit. No special new machines are required, since, thanks to the structure of the spacer according to the invention, conventional bending machines can be used such as those already available for metallic cold-bendable spacers.

In a preferred embodiment of the method, the spacer is bent at room temperature, i.e., at temperatures below 40° C., preferably at 15° C. to 30° C. Thus, no external heat source is required in order to preheat the spacer in the corners. This procedure is energy-saving and time-saving.

The invention furthermore comprises the use of the insulating glass unit according to the invention as building interior glazing, building exterior glazing and/or facade glazing.

The various embodiments of the invention may be implemented individually or in any combinations. In particular, the features mentioned above and explained below can be used not only in the specified combinations but also in other combinations or alone without departing from the scope of the present invention.

The invention is explained in more detail below with reference to drawings. The drawings are purely schematic representations and are not true to scale. They do not restrict the invention in any way. In the figures:

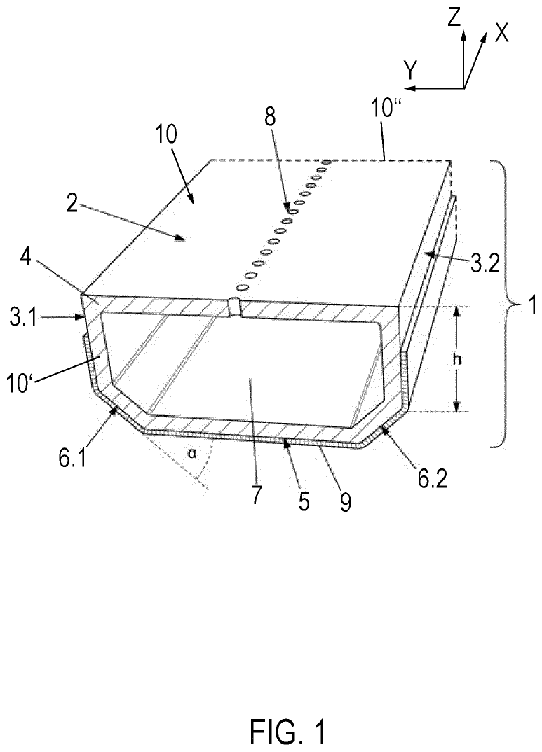

FIG. 1 shows a cross-section of an embodiment of the spacer,

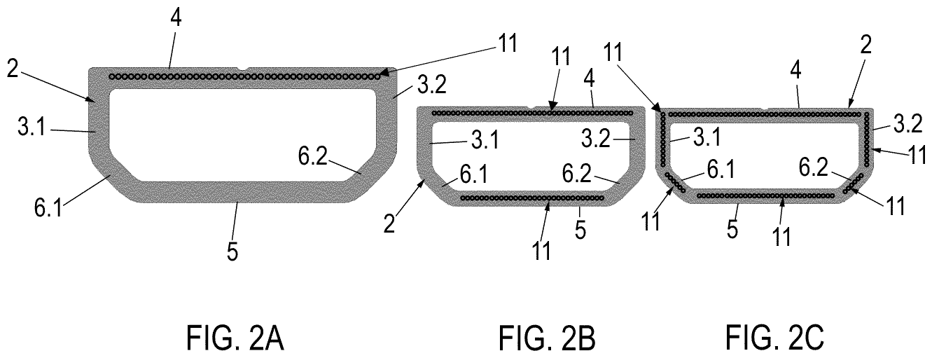

FIGS. 2A-2C each show cross-sections of different embodiments of the polymer hollow profile of the spacer from FIG. 1 with schematically illustrated continuous fibers which are not claimed in the claims,

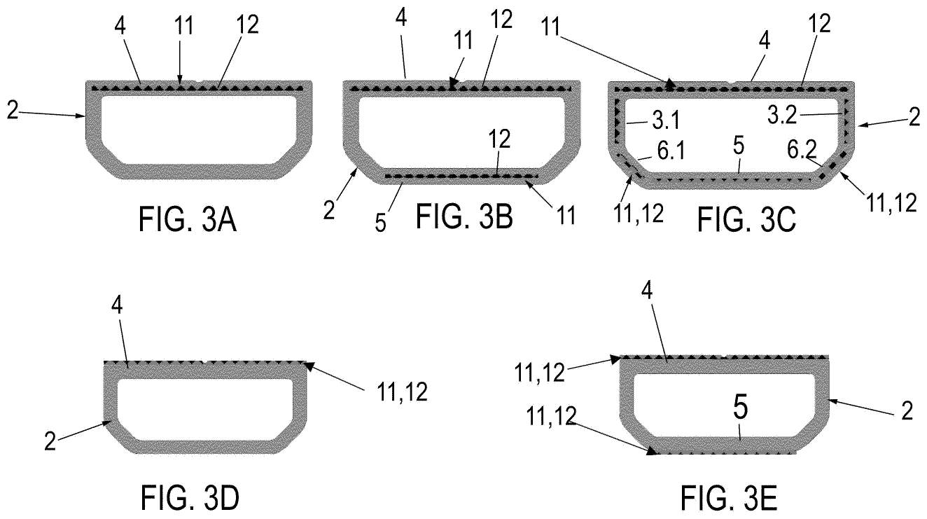

FIGS. 3A-3E each show cross-sections of different further embodiments of the polymer hollow profile of the spacer from FIG. 1 with schematically illustrated continuous fibers, wherein the embodiments of FIGS. 3A to 3C are not claimed in the claims,

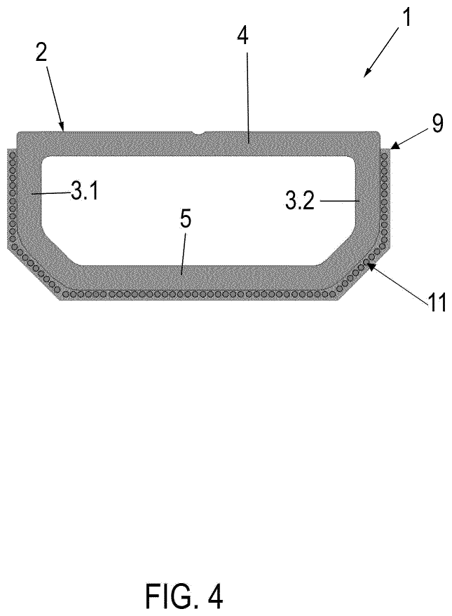

FIG. 4 shows a cross-section of a further possible embodiment of the spacer of FIG. 1 with schematically illustrated continuous fibers,

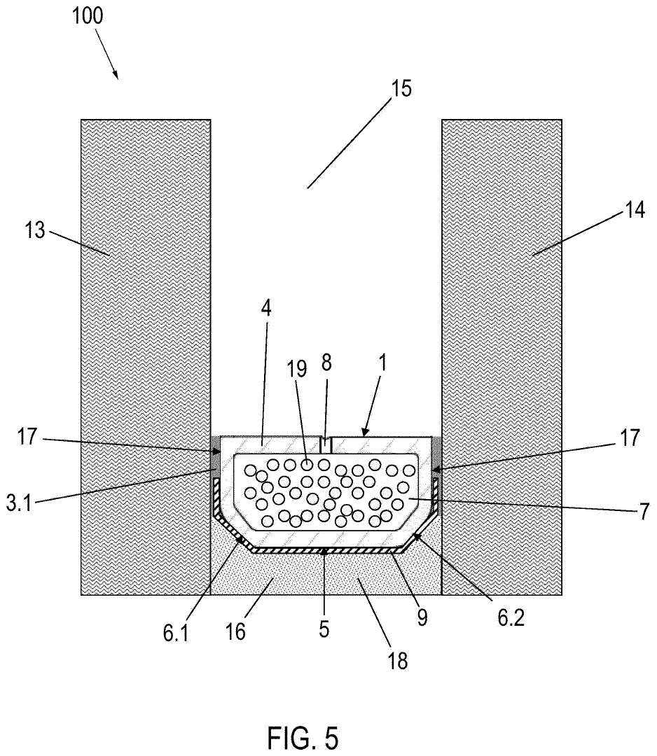

FIG. 5 shows a cross-section of an embodiment of the insulating glass unit according to the invention,

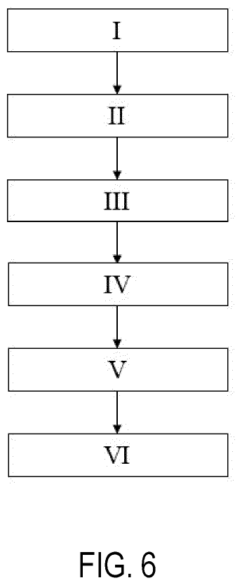

FIG. 6 shows a flow chart of the method according to the invention for producing an insulating glass unit according to the invention.

FIG. 1 shows a cross-section through a spacer 1 according to the invention, wherein the continuous fibers are not shown (see FIGS. 2A-2D to FIG. 4). The spacer 1 comprises a polymer hollow profile 2 which extends in the longitudinal direction X. The transverse direction Y is oriented perpendicular to the longitudinal direction X. The vertical direction Z is oriented perpendicular to the longitudinal and transverse directions. The hollow profile 2 consists, for example, of polypropylene, wherein other polymer materials are equally possible. The polymer hollow profile 2 comprises two parallel-running side walls 3.1 and 3.2. The side walls 3.1 and 3.2 are connected via an outer wall 5 and a glazing interior wall 4. Two angled connection walls 6.1 and 6.2 are arranged between the outer wall 5 and the side walls 3.1 and 3.2. The connection walls 6.1, 6.2 are preferably inclined at an angle α (alpha) of 30° to 60°, for example 45°, to the outer wall 5. The glazing interior wall 4 runs perpendicularly to the two side walls 3.1 and 3.2 and connects the two side walls 3.1 and 3.2 to each other. The outer wall 5 is opposite the glazing interior wall 4 and connects the two side walls 3.1 and 3.2. The angled geometry of the two connection walls 6.1, 6.2 improves the stability of the polymer hollow profile 2.

The respective outer sides or outer surfaces of the glazing interior wall 4, the outer wall 5 and the two side walls 3.1, 3.2 together form the common outer side or outer surface 10 of the polymer hollow profile 2.

The polymer hollow profile 2 has a cavity 7 which can be provided with a desiccant. Furthermore, the glazing interior wall 4 is provided with a plurality of openings 8 so that the desiccant can absorb moisture from the inner pane interspace 15 (see FIG. 5).

The wall thickness of the polymer hollow profile 2 is, for example, 1 mm. The width in the transverse direction Y of the polymer hollow profile 2 is, for example, 12 mm. The total height in the vertical direction z of the polymer hollow profile 2 is, for example, 6.5 mm.

A barrier film 9 is applied to the surface 10 of the outer wall 5, the connection walls 6.1, 6.2, and a part of the side walls 3.1, 3.2 approximately up to half the height h of the side walls 3.1, 3.2. The barrier film 9 is glued to the polymer hollow profile 2 using an adhesive (not shown). A transition region results on the side panes 3.1, 3.2, in which transition region the side panes 3.1, 3.2 are not provided with a barrier film 9. The barrier film 9 is not absolutely necessary.

The entire spacer 1 has, for example, a thermal conductivity of less than 10 W/(m K) and a gas permeation of less than 0.001 g/(m² h).

FIGS. 2A to 2C are now considered, in which cross-sections of different embodiments of the polymer hollow profile 2 of the spacer 1 of FIG. 1 are shown with schematically illustrated continuous fibers 11 (sections in the X-Z plane), which are not claimed in the claims. In order to avoid unnecessary repetitions, only the continuous fibers 11 are described. The barrier film 9 is not shown. The continuous fibers 2 are each formed as individual fibers and embedded in a wall of the polymer hollow profile 2. The polymer hollow profile 2 with the continuous fibers 11 is produced by pultrusion (i.e., extrusion of the hollow profile 2 with embedding of the continuous fibers 11, which are unwound from a particular bobbin). The continuous fibers 11 are arranged next to one another without intermediate connection, and all extend in the longitudinal direction X of the spacer 1 (with the proviso that it cannot be ruled out that continuous fibers that are separated due to the production process have a different direction). The continuous fibers 11 are, for example, glass or carbon fibers.

The various embodiments of FIGS. 2A to 2C differ in the embedding of the continuous fibers 11 in the walls of the polymer hollow profile 2. In FIG. 2A, the continuous fibers 11 are only embedded in the glazing interior wall 4. As a result of this measure, a clear improvement in the mechanical stiffness of the spacer 1 transversely to the longitudinal direction X, i.e., in the vertical direction Z, can be achieved. In general, an improvement in the mechanical stiffness with a bending component in the vertical direction Z can be achieved. This is particularly important for practical use. In FIG. 2B, the continuous fibers 11 are only embedded in the glazing interior wall 4 and in the outer wall 5. The mechanical stiffness of the spacer 1 in the vertical direction Z can thereby be further improved. In FIG. 2C, the continuous fibers 11 are embedded in the glazing interior wall 4, the outer wall 5, the two side walls 3.1, 3.2, and the two connection walls 6.1, 6.2. The mechanical stiffness of the spacer 1 in all directions can thereby be considerably improved.

In the embodiments of FIGS. 2A to 2C, the continuous fibers 11 extend “infinitely” in the longitudinal direction X of the spacer 1, i.e., they each run from an end-face surface 10′ (end face) of the polymer hollow profile 2 and end at the opposite end face surface 10′ (end face) of the polymer hollow profile 1 in the longitudinal direction X. The two end-face surfaces 10′, 10″, which are characterized in FIG. 1, delimit the polymer hollow profile 2 in the longitudinal direction X.

In FIGS. 3A to 3E, cross-sections of different further embodiments of the polymer hollow profile 2 of the spacer 1 of FIG. 1 are shown with schematically illustrated continuous fibers 11 (sections in the X-Z plane), wherein the embodiments of FIGS. 3A to 3C are not claimed in the claims. In order to avoid unnecessary repetitions, only the continuous fibers 11 are described. The barrier film 9 is not shown.

The continuous fibers 11 of FIGS. 3A to 3E differ from the continuous fibers 11 of FIGS. 2A to 2C in that they are embedded in a matrix, i.e., a carrier 12 made of polymer material. Here, the continuous fibers 11 with a carrier 12 are formed, for example, into a tape. The carrier 12 with the continuous fibers 11 can in particular be embedded by co-extrusion with the polymer hollow profile 2 into the hollow profile 2. The various embodiments of FIGS. 3A to 3C differ in the embedding of the carriers 12 with continuous fibers 11 into the walls of the polymer hollow profile 2. In FIG. 3A, the carrier 12 with continuous fibers 11 is embedded only in the glazing interior wall 4. In FIG. 3B, the carrier 12 with continuous fibers 11 is embedded only in the glazing interior wall 4 and in the outer wall 5. In FIG. 3C, the carrier 12 is embedded with continuous fibers 11 in the glazing interior wall 4, the outer wall 5, the two side walls 3.1, 3.2, and the two connection walls 6.1, 6.2. The mechanical stiffness of the spacer 1 can be significantly improved analogously to FIGS. 2A to 2C.

In the embodiments of FIGS. 3D and 3E, the carrier 12 is arranged and fastened with continuous fibers 11 on the surface 10 of the polymer hollow profile 2, for example by gluing or welding (not shown). In FIG. 3C, the carrier 12 with continuous fibers 11 is applied only to the surface 10 of the glazing interior wall 4. In FIG. 3D, the carrier 12 with continuous fibers 11 is applied only to the surface 10 of the glazing interior wall 4 and the outer wall 5. The mechanical stiffness of the spacer 1 in the vertical direction Z or with a bending component in the vertical direction Z can thereby be further improved. In addition, continuous fibers can be embedded in the polymer hollow profile 2, as illustrated in the embodiments of FIGS. 3A, 3B and 3D.

FIG. 4 shows a cross-section of a further possible embodiment of the spacer 1 of FIG. 1 with schematically illustrated continuous fibers 11. In this embodiment, the continuous fibers 11 are embedded in the barrier film 9, whereby the barrier film 9 advantageously achieves a dual function. On the one hand, it improves the gas and vapor tightness of the spacer 1, and on the other hand it serves to improve the mechanical stiffness.

Although this is not shown in the figures, it would equally be possible for the continuous fibers 11 to be arranged in a woven or non-woven composite, for example in a mesh network or a woven or non-crimp fabric.

FIG. 5 shows a cross-section of the edge region of an insulating glass unit 100 according to the invention with the spacer 1 shown in FIG. 1. For the sake of clarity, continuous fibers 11 are not shown. These can be designed, for example, as shown in FIGS. 2A to 2C, 3A to 3D and 4.

In the insulating glass unit 100, a first pane 13 is connected to the first side wall 3.1 of the spacer 1 via a primary sealant 17, and a second pane 14 is attached to the second side wall 3.2 via the primary sealant 17. The primary sealant 17 contains a crosslinking polyisobutylene. An inner pane interspace 15 is located between the first pane 13 and the second pane 14 and is delimited by the glazing interior wall 4 of the spacer 1 according to the invention. The cavity 7 is filled with a desiccant 19, for example a molecular sieve. The cavity 7 is connected to the inner pane interspace 15 via openings 8 in the glazing interior wall 4. Through the openings 8 in the glazing interior wall 4, a gas exchange takes place between the cavity 7 and the inner pane interspace 15, wherein the desiccant 19 absorbs the air moisture from the inner pane interspace 15. The first pane 13 and the second pane 14 project beyond the side walls 3.1 and 3.2 so that an outer pane interspace 16 is produced, which is located between the first pane 13 and the second pane 14 and is delimited by the outer wall 5 with the barrier film 9 of the spacer 1. The outer pane interspace 16 is filled with a secondary sealant 18. The secondary sealant 18 is a silicone, for example. Silicones absorb the forces acting on the edge bond particularly well and therefore contribute to high stability of the insulating glass unit 100. The first pane 13 and the second pane 14 consist of soda-lime glass of a thickness of 3 mm.

FIG. 9 shows a flow chart of the method according to the invention for producing an insulating glass unit 100 according to the invention. The reference signs I to VI have the following meaning:
I) providing a spacer according to the invention,
II) bending the spacer into a spacer frame which is closed at one point,
III) providing a first pane and a second pane,
IV) fastening the spacer by means of a primary sealant between the first pane and the second pane,
V) compressing the pane arrangement of the panes and the spacer, and
VI) filling the outer pane interspace with a secondary sealant.

As can be seen from the above description of the invention, the invention provides a novel spacer with continuous fibers which, compared to conventional spacers, has a significantly improved mechanical stiffness, in particular longitudinal stiffness, with a very good thermal insulation capability. The thermal conductivity is significantly lower than that of metallic spacers. The spacer according to the invention also offers the possibility of producing a spacer frame by bending, for example, for forming corners at low temperatures such as room temperature. In industrial mass production, insulating glass units can be produced efficiently and cost-effectively.

### LIST OF REFERENCE SIGNS

1 Spacer
2 Hollow profile
3.1 First side wall
3.2 Second side wall
4 Glazing interior wall
5 Outer wall
6.1 First connection wall
6.2 Second connection wall
7 Cavity
8 Opening
9 Barrier film
10 Surface
10′, 10″ End-face surface
11 Continuous fiber
12 Carrier
13 First pane
14 Second pane
15 Inner pane interspace
16 Outer pane interspace
17 Primary sealant
18 Secondary sealant
19 Desiccant
100 Insulating glass unit

1. A spacer for insulating glass units, comprising:
a polymer hollow profile extending in a longitudinal direction, having a first side wall and a second side wall arranged parallel thereto, a glazing interior wall which extends in a transverse direction between the first and second side walls and connects them to one another, an outer wall which is arranged at least partially parallel to the glazing interior wall and perpendicular to the first and second side walls and connects the first and second side walls to one another, and a cavity which is enclosed by the first and second side walls, the glazing interior wall and the outer wall,
a plurality of continuous fibers, wherein each continuous fiber has a fiber length along its extension which corresponds to a dimension of the polymer hollow profile along the extension of the continuous fiber,
wherein the plurality of continuous fibers are embedded in a polymer carrier, and
wherein a polymer carrier is arranged with the plurality of continuous fibers on a surface of the glazing interior wall, and/or a surface of the outer wall, and/or a surface of the first side wall, and/or a surface of the second side wall.

2. The spacer according to claim 1, wherein the polymer material from which the polymer carrier is made and the polymer material from which the polymer hollow profile is made are identical.

3. The spacer according to claim 1, wherein a diffusion barrier is applied to the first side wall, to the outer wall and to the second side wall of the polymer hollow profile, wherein the plurality of continuous fibers are embedded in the diffusion barrier serving as a polymer carrier.

4. The spacer according to claim 3, wherein the diffusion barrier is a multilayer film.

5. The spacer according to claim 1, wherein the plurality of continuous fibers have an identical extension direction.

6. The spacer according to claim 1, wherein continuous fibers of a first set of the plurality of continuous fibers each have a first extension direction, and continuous fibers of at least one second set of the plurality of continuous fibers each have a second extension direction which is different from the first extension direction.

7. The spacer according to claim 6, wherein the plurality of continuous fibers are present:
as individual fibers, and/or
in a woven composite, and/or
in a non-woven composite.

8. The spacer according to claim 1, wherein the plurality of continuous fibers are embedded into the glazing interior wall and/or the outer wall of the polymer hollow profile.

9. The spacer according to claim 8, wherein the plurality of continuous fibers are embedded in the first side wall and/or the second side wall of the polymer hollow profile.

10. An insulating glass unit, comprising a first pane, a second pane, and a spacer according to claim 1 arranged peripherally between the first pane and the second pane, wherein
the first pane is attached to the first side wall by a primary sealant,
the second pane is attached to the second side wall by the primary sealant,
an inner pane interspace is delimited by the glazing interior wall, the first pane and the second pane,
an outer pane interspace which is delimited by the diffusion barrier mounted on the outer wall and by the first pane and the second pane,
a secondary sealant is arranged in the outer pane interspace.

11. A method for producing an insulating glass unit according to claim 10, comprising:
providing the spacer,
bending the spacer into a spacer frame which is closed at one point,
providing the first pane and the second pane,
fastening the spacer by the primary sealant between the first pane and the second pane,
compressing a pane assembly of the first and second panes and the spacer, and
filling the outer pane interspace with a secondary sealant.

12. The method for producing an insulating glass unit according to claim 11, wherein the spacer is bent into a spacer frame at temperatures below 40° C.

13. A method comprising providing the insulating glass unit according to claim 10 as building interior glazing, building exterior glazing and/or facade glazing.

14. The spacer according to claim 4, wherein the diffusion barrier includes at least one polymer layer.

15. The spacer according to claim 4, wherein the diffusion barrier includes one thick metallic layer having a thickness between 2 μm and 8 μm.

16. The spacer according to claim 5, wherein the identical extension direction corresponds to the longitudinal direction of the polymer hollow profile.

17. The spacer according to claim 6, wherein the first extension direction corresponds to the longitudinal direction of the polymer hollow profile.

18. The spacer according to claim 8, wherein the plurality of continuous fibers extend in a form of individual fibers in the longitudinal direction of the polymer hollow profile.
